(19) United States
(12) Patent Application Publication
(10) Pub. No.: US 2006/0273121 A1
(43) Pub. Date: Dec. 7, 2006

(54) Light bar mounting assembly for emergency vehicles

(76) Inventor: George E. Thomas, Oregon City, OR (US)

Correspondence Address: OLSON AND OLSON, 5412 SE FOSTER ROAD, PORTLAND, OR, 97206, US

(21) Appl. No.: 11/144,240

(22) Filed: Jun. 2, 2005

(51) Int. Cl. B60R 9/00; B60Q 7/00; B60Q 1/00

(52) U.S. Cl. 224/322; 224/329; 340/473; 362/549; 362/542; 362/493

(57) ABSTRACT

The light bar mounting assembly of this invention includes a light bar support having a pair of laterally adjustable extension members projecting from each side of a light bar configured for releasable clamping engagement with vehicle side door indentations, whereby to secure the light bar removably to the roof of a vehicle, particularly emergency vehicles. In one embodiment the light bar support is configured with adjustable securing components that allows reception within the perimeter of a light bar, and suction cups secure the support elevated above the roof of a vehicle. In another embodiment the light bar support is configured for use with laterally wider light bars and is provided with adjustable clamp components for securing the assembly to a vehicle roof.

### BACKGROUND OF THE INVENTION

This invention relates to the mounting of light bars on emergency vehicles, and more particularly to a support assembly capable of mounting a variety of sizes and shapes of light bars on emergency vehicles.

Prior light bar supports for vehicles are configured to mount a specific structural form of light bar, as disclosed in U.S. Pat. No. 3,721,374. However, there are several configurations presently employed on different emergency vehicles, each requiring a different and therefore more costly mounting structure.

### SUMMARY OF THE INVENTION

The light bar mounting assembly of this invention includes components that are adjustable to accommodate the mounting of diverse light bar configurations on various types and styles of automobile roofs.

It is the principal objective of this invention to provide a light bar mounting assembly that overcomes the disadvantages and limitations of prior light bar mounting assemblies.

Another objective of this invention is a light bar mounting assembly that accommodates the mounting of a variety of configurations of light bars on a variety of configurations of vehicle roofs.

Still another objective of this invention is to provide a light bar mounting assembly that accommodates the exchange of diverse light bars.

A further objective of this invention is the provision of a light bar mounting assembly that accommodates light bars with depending peripheries.

A still further objective of this invention is to provide a light bar mounting assembly that affords mounting on a vehicle roof in a forwardly offset position relative to the transverse anchor on the roof for added wind resistance.

Still another objective of this invention is to provide a light bar mounting assembly of simplified construction for economical manufacture.

The foregoing and other objects and advantages of this invention will appear from the following detailed description taken in connection with the accompanying drawings of preferred embodiments.

### BRIEF DESCRIPTION OF THE DRAWINGS

FIG. 1 is a transverse elevational view of a light bar mounting assembly embodying the features of this invention, the view being from the rear end of a vehicle showing the profile of a vehicle roof in broken lines.

FIG. 2 is a perspective view, on an enlarged scale, of the longitudinally adjustable clamping configuration of the light bar mounting assembly of FIG. 1.

FIG. 3 is a fragmentary exploded perspective view of the right end portion of the light bar mounting assembly of FIG. 2 illustrating the manner of attachment of a light bar mounting base to the adjustable extension assembly.

FIG. 4 is a fragmentary exploded perspective view of the right end portion of the light bar mounting assembly of FIG. 3 illustrating the adjustable configuration of the lateral extension mechanism.

FIG. 5 is a bottom plan view of the light bar secured to the supporting base plate of FIGS. 1-4 and showing the bottom periphery of the light bar surrounding the base plate, and further showing the manipulation of the spaced anchor components with one installed in operative position and the other angled across the base plate in an intermediate position of installation.

FIG. 6 is a transverse sectional view, on an enlarged scale, taken on the line 6-6 in FIG. 2, the profile of the light bar being shown in broken lines.

FIG. 7 is a transverse elevational view, similar to FIG. 1, and illustrating a second embodiment of light bar mounting assembly.

FIG. 8 is a fragmentary view, on an enlarged scale, of the right end portion of FIG. 7.

FIG. 9 is a sectional view taken along the line 9-9 in FIG. 8.

### DESCRIPTION OF THE PREFERRED EMBODIMENTS

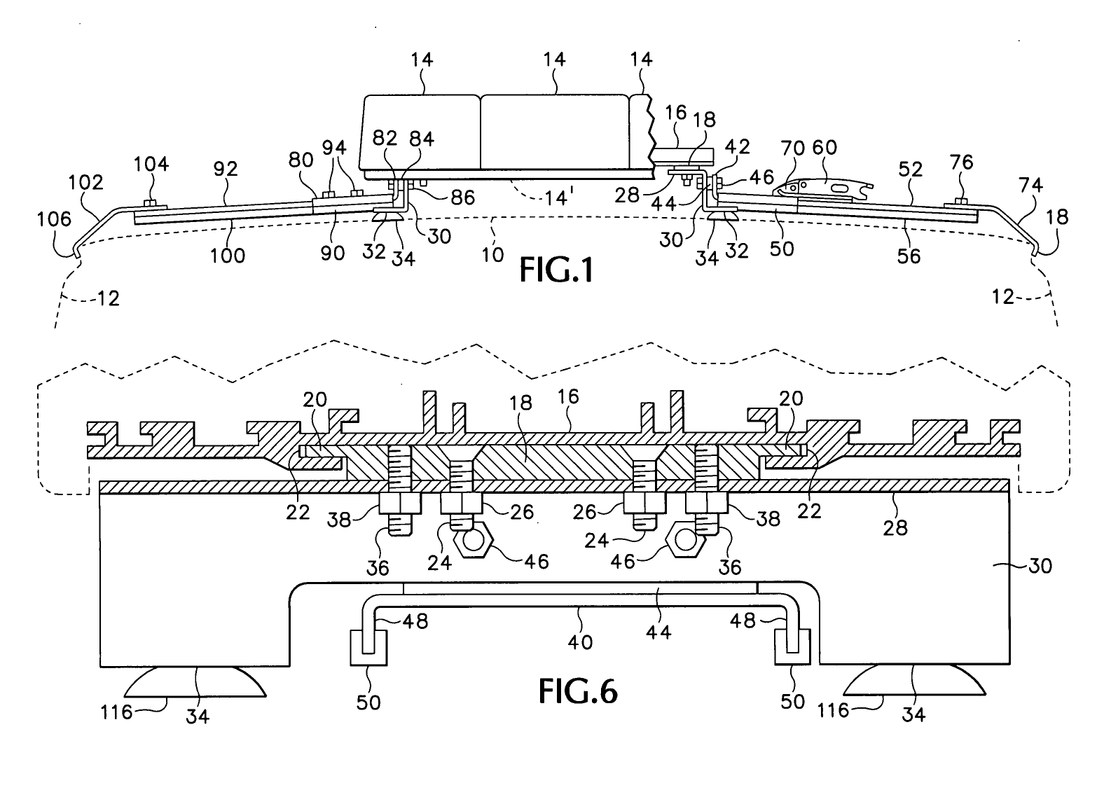

FIG. 1 illustrates one embodiment of the light bar mounting assembly of this invention installed on the roof 10 of an automotive vehicle such as a police car. The indented door edge 12 serves to clamp the assembly to the roof 10 by mechanism described hereinafter. A light bar 14 having multiple emergency lights is secured to a light bar base support 16 by coupler members 18 provided with laterally projecting side flanges 20 for removable reception in the flange grooves 22 of the light bar base 16. Anchor screws 24 and cooperating lock nuts 26 secure the coupler member 18 to an angle iron base segment 28 of a support member which includes spacer segment 30 extending normal to the base segment, and foot segments 32 projecting outward from the spacer segment. Suction cups 34 are mounted on the foot segments and serve to secure the light bar base 16 to the roof 10.

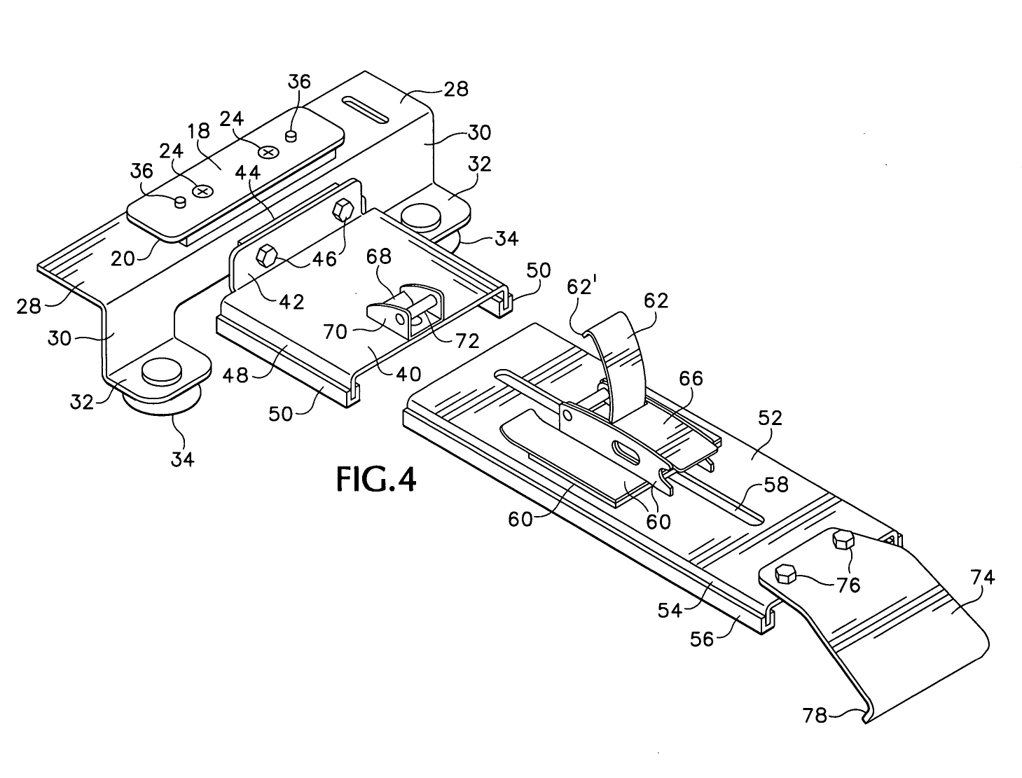

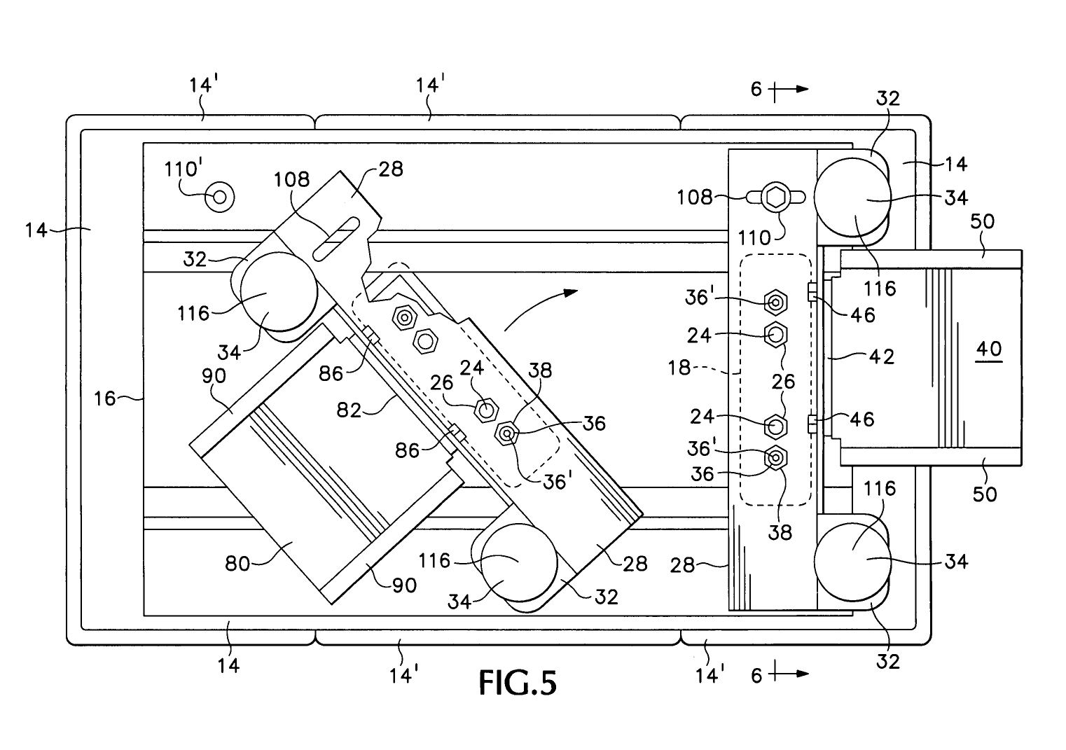

Clamp screws 36 extend through the angle iron base segment 28 and into threaded openings in the coupler member 18, by use of a hex screwdriver (not shown) receivable in a hex socket 36′ (FIG. 5) in the clamp screws. Rotation of the clamp screws brings them into abutment with the undersurface of the base support 16, drawing the coupler member 18 downward into frictional pressure engagement of the side flanges 20 in the grooves 22. Lock nut 38 secures the clamp screws against loosening.

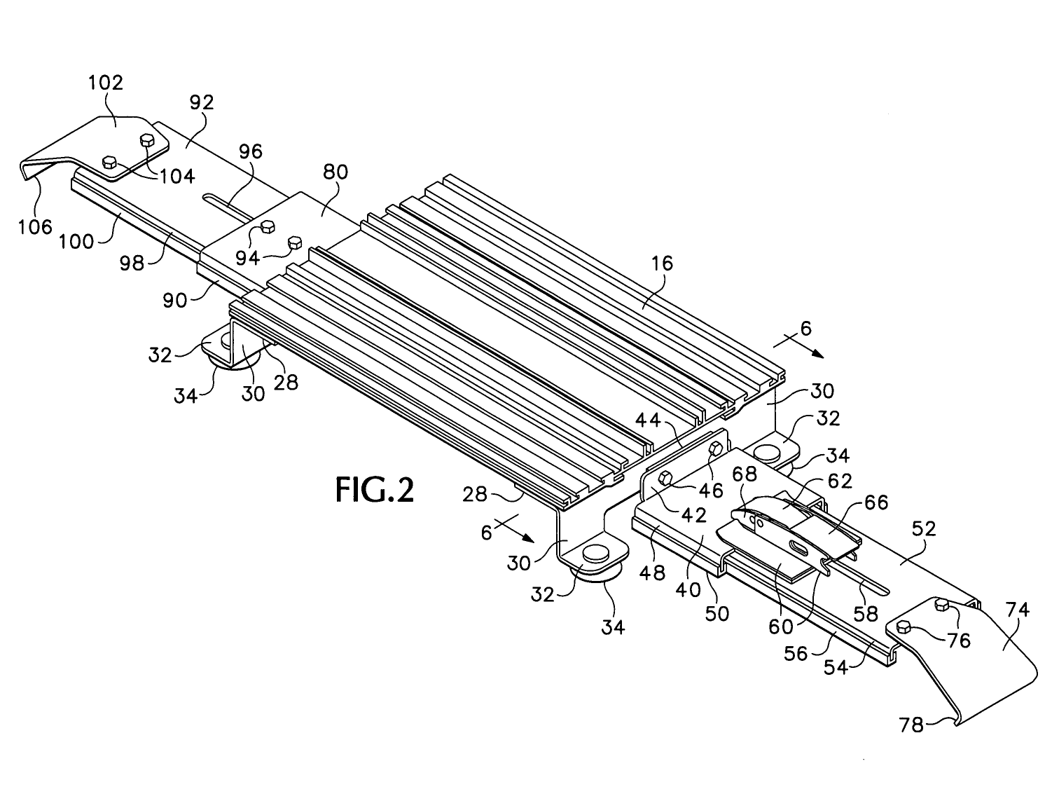

Referring now to FIG. 2 of the drawings, an end connector segment 40 is provided with an upturned flange 42 on one end and a resilient rubber buffer 44 secured to the outer side of the flange 42 to provide a resilient connection of the end segment 40 to the spacer segment 30 of the angle iron base segment 28 by flange bolts 46. Downturned side flanges 48 on the end segment support the U-shaped rubber buffers 50, for protecting the vehicle roof against scratches or other damage.

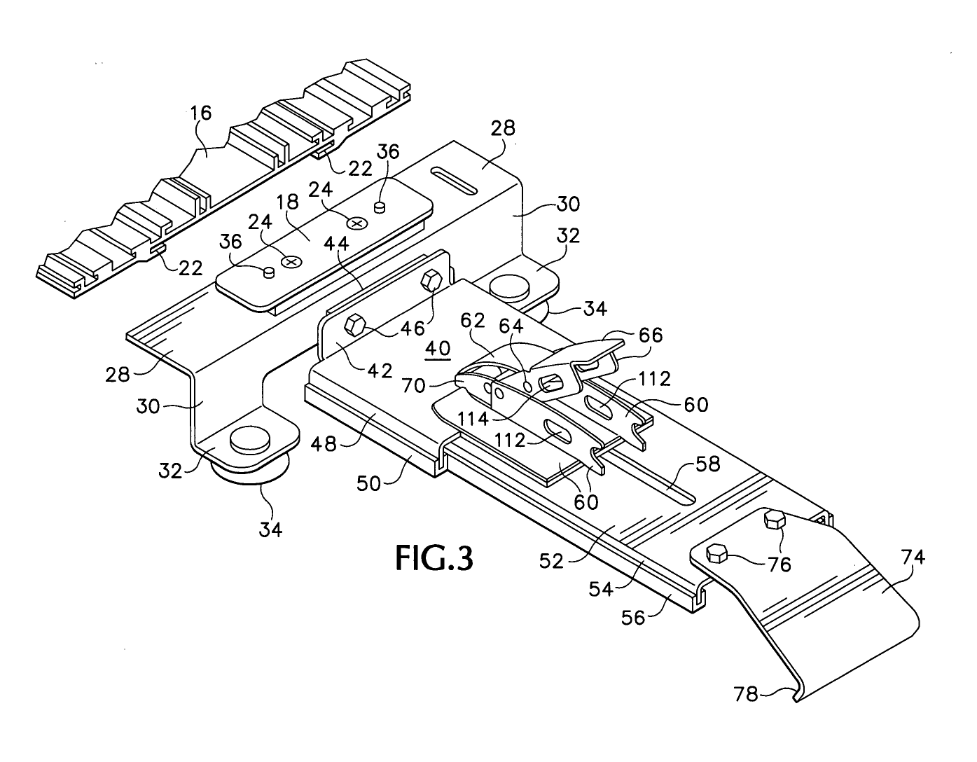

An elongated extension member 52 is provided with downturned side flanges 54, fitted with rubber buffers 56. Member 52 is configured for slidable reception under the end segment 40 and is provided with an elongated longitudinal slot 58 through which to receive a clamp screw (not shown) for securing the anchor member 60 at desired position along the length of the extension member 52. The anchor member 60 mounts a toggle latch 62 provided with a hook catch end 62′ (FIG. 4), by pivot pin 64 (FIG. 3). The toggle latch 62 is connected by pivot 64 to U-shaped actuator member 66.

The hook end 62′ of the toggle latch is arranged to engage the toggle hook anchor catch 68 mounted on the U-shaped support member 70 secured to the end segment 40 by screws, rivets, or other suitable means (not shown). A reinforcing pin 72 limits the movement of the catch 68 to insure positive engagement of the toggle latch end 62′.

A door edge clamp member 74 is secured by anchor bolts 76 to the laterally outward end of the extension member 52, and is provided with a hook end 78 configured to engage the indented door edge seat 12 at one side of the vehicle roof 10.

Referring again to FIGS. 1 and 2 of the drawings, the opposite end of the base support 16 also has an end segment 80 secured to the adjacent spacer segment 30 of a corresponding angle iron base support segment 28. The upturned flange 82 and associated rubber buffer 84 are secured by bolts 86 to the spacer segment 30. The downturned side flanges 88 support rubber buffers 90. An elongated extension member 92 is secured adjustably to the end segment 80 by means of bolts 94 extended freely through an elongated slot 96 in the extension member 92. Downturned side flanges 98 on the extension member 92 support rubber buffers 100.

The door edge clamp 102 is secured to the outer end of the extension member 92 by anchor bolts 104, and the hook end 106 of the edge clamp 102 serves to engage the indented door edge seat 12 in the manner of the hook end 78 of the opposite edge clamp.

Referring now to FIG. 5 of the drawings, provision is made for securing the angle iron base support segment 28 to the underside of the light bar base support 16. As illustrated in FIG. 5, the light bar 14 has a peripheral wall 14′ that extends downwardly beyond the base support 16, as clearly shown in FIGS. 1 and 6. This downward flange prevents the installation of the angle iron base support. Accordingly, the base support segment 28 at each end of the base support 16 is provided adjacent one end with an elongated slot 108 configured to freely receive an anchor screw 110 for threaded engagement in threaded bore 110′ in the base support 16. This allows the angle iron base support to be rotated about the axis of the screw 110 from the angular position illustrated by the angle iron base support at the left in FIG. 5 (initially registering the slot 108 with the threaded bore 110′) and then rotating the assembly clockwise to the position matching the angle iron base support at the right in FIG. 5. It is by this rotation that the side flanges 20 on the coupler member 18 are brought into engagement in the grooves 22, thereby securing the light bar support base 16 and light bar 14 to the angle iron base support segment 28.

The mode of operation of the embodiment of FIGS. 1-6 described hereinbefore, is as follows: The light bar 14 is secured to the base 16 by means of the notched couplers on the coupler member 16, and by threaded holes formed in the coupler member at selected position to receive anchor screws carried by the light bar. With the light bar and coupler member inverted as in FIG. 5, the angle iron base members 28-34 are installed on the underside of the coupler member as described hereinbefore, and the assembly is inverted to upright position on a vehicle roof 10, with the suction cups 34 collapsed to secure the light bar and base member assembly to the roof.

In the event the suction cups are found to grip the roof too tenaciously, a pin hole 116 (FIG. 5) may be formed in each suction cup in a position in which the inner end thereof is closed when the suction cup is in collapsed, securing condition. Thus, release of the suction cup may be achieved simply by pulling upward on the suction cup in the area overlying the pin hole. Air thus is allowed to be drawn into the inner cavity of the suction cup to allow it to release.

The assembly of end segment 80, extension member 92 and door edge clamp 102 is installed and adjusted in length, by loosening the anchor bolts 94 and adjusting the position of the end segment 92 relative to the end segment 80, with the hook end 106 engaging the indented door edge seat 12. The bolts 94 then are tightened to secure the connection. The light bar thus is positioned on the vehicle roof 10 in desired location.

The assembly of end segment 40, extension member 52 and door edge clamp 74 then is connected to the opposite end of the base support 16, and the end extension member 52 is adjusted longitudinally relative to the end segment 40 with the hook end 78 of the door edge clamp 74 engaging the corresponding indented edge seat 12 of the vehicle roof The toggle latch anchor member 60 then is adjusted along the slot 58 to bring it in to close proximity to the toggle hook anchor support member 70. The toggle latch 62 then is swung downward to engage the hook end 62′. The toggle latch actuator member 66 then is swung downwardly to pull toggle latch catch 62′ into firm engagement with the toggle hook anchor catch 68. The toggle hook anchor catch 68 may bend rearward, under the pressure of the actuator member 66, in which case the anchor catch will engage the reinforcing pin 72 to limit its deformation.

With both end segment assemblies thus secured to the indented door edge seats 12 at opposite sides of the vehicle, the installation is complete.

If desired, the bail portion of a padlock may be extended through the aligned openings 112 and 114 to secure the assembly against inadvertent separation.

It is an important feature of this invention that the opposite side extension assemblies be mounted in a forwardly offset position relative to the lateral center line of the light bar base support 16, as is clearly illustrated in FIGS. 2-6. It has been determined that this forward offset prevents the pressure of the wind at high speeds of the vehicle from dislodging the light bar assembly on the vehicle roof.

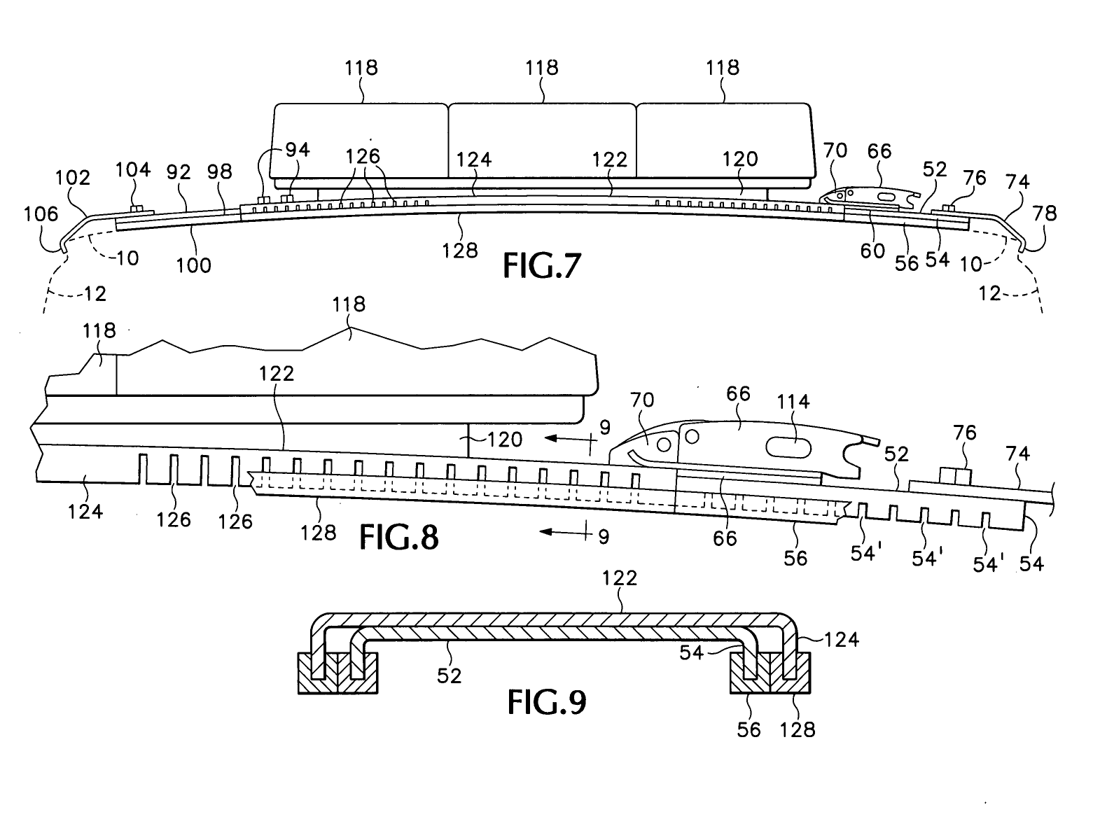

Referring now to the embodiment illustrated in FIGS. 7-9, it is to be noted that the light bar 118 is much longer than the light bar 14 described hereinbefore. The light bar base support 16 is replaced by the longer base support 120, and the extension members 40 and 80 are replaced by the single elongated connecting member 122. Any number of different light bars 118 may be secured to the connectig member 120 by bolts or screws extending through registering openings provided in the light bar and connecting members. The connecting member has downturned side flanges 124 in which a multiplicity of spaced notches 126 are located along a substantial portion of the end segments of the extension member 122. These notches allow the extension member 122 to bend resiliently to conform to the curvature of the surface of the vehicle roof. U-shaped rubber buffers 128 are pressed onto the downward flanges 124 to protect the vehicle roof from scratching and other damage.

One end of the extension member 122 is coupled to an end extension member 52 (FIG. 8) having downturned side flanges 54 supporting spaced notches 54′ and rubber buffers 56, as described hereinbefore. The extension 52 is telescoped within the main central extension 122, as illustrated in FIG. 9, and it supports the toggle latch mechanism 60-66 for cooperative engagement with toggle hook anchor assembly 68-72 secured to the corresponding end of the extension member 122. The extension member 52 mounts a door edge clamp 74, by anchor bolts 76 and is provided with the hook end 78 for releasable engagement with the indented door edge seat 12, as described hereinbefore. The end extension 92 is received telescopically within the opposite end of the central extension member 122 and is secured in desired adjustment by anchor bolts 94 extended slidably through the longitudinal slot 96. The extension 92 is provided with downturned side flanges 98 which support rubber buffers 100, all as explained hereinbefore in connection with the first embodiment. Door edge clamp 102 is secured to the end of the extension member 92, by anchor bolts 104, and the hook end 106 is configured to engage the indented door edge seat 12 at the opposite side of the vehicle roof.

As in the embodiment described hereinbefore, the light bar base support 120 preferably is secured to the central extension member 122 in a forwardly offset position to resist the force of wind resulting from high speed movement of the vehicle, as described hereinbefore. Additionally, the openings 112 and 114 in the members 60 and 66, respectively, afford reception of a padlock bail, to secure against theft.

The manner of use of the embodiment of FIGS. 7-9 is analogous to that of the first embodiment of FIGS. 1-6.

It will be apparent to those skilled in the art that various modifications and changes may be made in the size, shape, type, number and arrangement of the structural components described hereinbefore without departing from the spirit of this invention and the scope of the appended claims.

I claim:

1. A light bar mounting assembly for removable attachment to the roof: of a vehicle, comprising:
a) a light bar support member configured for attachment to a light bar and having outer lateral ends,
b) extension means connected to said support member and arranged for extending toward the opposite sides of a vehicles,
c) extension segments on the outer ends of said extension means, at least one of said segments being adjustable longitudinally toward and away from the corresponding side of a vehicle, and
d) securing means on the outer end of each outer extension segment for securing said light bar to a vehicle roof.

2. The light bar mounting assembly of claim 1 wherein the light bar support member includes a base member adapted to be secured to the bottom side of a light bar, a base support member having an attachment segment secured to the base member, a spacer segment extending perpendicularly from the attachment segment, a pair of spaced foot segments extending perpendicularly from the spacer segment, and a suction cup mounted on each of the spaced foot segments and arranged for removable attachment to a vehicle roof.

3. The light bar mounting assembly of claim 2 including a pinhole extending through the suction cups and terminating at the inner end in a position which is closed when the suction cup is collapsed.

4. The light bar mounting assembly of claim 1 including connector latch means interengaging the support member and extension segment on one lateral end of the support member for drawing said support member and extension segment to shorter combined length, for moving said securing means toward light bar roof securing position.

5. The light bar mounting assembly of claim 4 wherein the connector latch means includes lock engaging means for locking the latch means against separation of said support member and extension segment.

6. The light bar mounting assembly of claim 1 wherein the light bar and support member are secured to the extension means and extension segments in a forwardly offset position to provide increased resistance to wind force of high vehicle speed.

7. The light bar support member of claim 1 wherein the securing means comprises a clamp member on the outer end of each extension segment for clamping said light bar support to side components of a vehicle.

8. The light bar mounting assembly of claim 1 including pivot means associated with the base member for mounting the latter for pivotal movement between an initial position on the base member disposed annular relative to final secured position.

9. The light bar mounting assembly of claim 1 wherein said extension means and extension segments include protection means for engaging the roof of a vehicle and protecting the roof against damage.

10. The light bar mounting assembly of claim 1 wherein the light bar support member comprises an elongated member having downturned side flanges, and the extension means has downturned side flanges and is connected to one end of the elongated member for adjustment longitudinally for securing said support member to the roof of a vehicle.

11. A light bar mounting assembly for removable attachment to the roof of a vehicle, comprising:
a) a light bar support member configured for removable attachment to a light bar and having outer lateral ends,
b) extension means connected to said support member and arranged for extending toward the opposite sides of a vehicle,
c) extension segments on the outer ends of said extension means, at least one of said segments being adjustable longitudinally toward and away from the corresponding side of a vehicle, and
d) connector latch means interengaging the support member and extension segment on one lateral end of the support member for drawing said support member and extension segment to shorter combined length, for moving said securing means toward a light bar roof securing position,
e) the connector latch means including lock engaging means for locking the latch means against separation of said support member and extension segment.

12. A light bar mounting assembly for removable attachment to the roof of a vehicle, comprising:
a) a light bar support member configured for attachment to a light bar and having outer lateral ends, the light bar support member including a base member adapted to be secured to the bottom side of a light bar, a base support member having an attachment segment secured to the base member, a space segment extending perpendicularly from the attachment segment, a pair of spaced foot segments extending perpendicularly from the spaced segment, and a suction cup mounted on each of the spaced foot segments and arranged for removable attachment to a vehicle roof,
b) extension means connected to said support member and arranged for extending toward the opposite sides of a vehicle,
c) extension segments on the outer ends of said extendings, at least one of said segments being adjustable longitudinally toward and away from the corresponding side of a vehicle,
d) a clamp member on the outer end of each extension segment for clamping said light bar support to side components of a vehicle,
e) connector latch means interengaging the support member and extension segment on one lateral end of the support member for drawing said support member and extension segment to shorter combined length, for moving said securing means toward light bar roof securing position, and
f) lock engaging means on the connector latch means for locking the latch means against separation of said support member and extension segment,
g) the light bar and support member being secured to the extension means and extension segments in a forwardly offset position to provide increased resistance to wind force of high vehicle speed.
